(19) United States
(12) Patent Application Publication
(10) Pub. No.: US 2003/0023792 A1
(43) Pub. Date: Jan. 30, 2003

(54) Mobile phone terminal with text input aid and dictionary function

(76) Inventor: Tobias Schneider, Muenchen (DE)

Correspondence Address: Bell, Boyd & Lloyd LLC, P. O. Box 1135, Chicago, IL, 60690, US

(21) Appl. No.: 10/205,068

(22) Filed: Jul. 25, 2002

(30) Foreign Application Priority Data
Jul. 26, 2001 (EP) 01117704.5

(51) Int. Cl. G06F 13/12

(52) U.S. Cl. 710/73

(57) ABSTRACT

A terminal for data processing and/or communications technology is provided with multiply assigned input keys, having at least two language-specific word lists and having parts for assigning words to the characters which are input via the input keys. An interlinking list is also provided in which corresponding words in the language-specific word lists are listed, as a result of which a dictionary function is implemented.

### BACKGROUND OF THE INVENTION

Such a terminal for communications technology is, for example, a mobile phone terminal or cell phone such as is preferably used in cellular networks. A terminal for data processing technology is, for example, a palm top. These small mobile terminals generally have a twelve-key keypad which is used for inputting numerals. In order to input alphanumeric characters, individual numerical keys are multiply assigned. Thus, for example, the key for the numeral “2” is also used to input the letters “A, B, C”, and the key for the numeral “3” is also used for inputting the letters “D, E, F”, etc. The numerical keys are, therefore, multiply assigned when inputting letters or texts. In order to overcome this ambiguity, the numerical key “2” is generally pressed twice to input the letter “B” and, for example, the numerical key “3” is pressed once to input the letter “D”.

In addition, what are referred to as input aids are known; for example, T9 from Tegic. Such text input aids are based on large language-specific word lists. When a text or a word is input, each of the multiply assigned keys is pressed only once and one or, if appropriate, more words are displayed for selection from the word list at the end of the word. The word lists are very extensive having, for example, 50,000 words or more, and are generally provided in several languages on the terminals.

The present invention is directed toward extending or simplifying the scope of use of such a terminal.

### SUMMARY OF THE INVENTION

The terminal according to the present invention has not only the text input aid but also a dictionary function without a large degree of additional expenditure.

Specifically, a terminal is provided for data processing and/or communications technology with multiply assigned input keys, which includes at least two language-specific word lists, parts for assigning words in the word lists to characters which are input via the input keys, and an interlinking list for listing corresponding words from the language-specific word lists, wherein a dictionary function is implemented.

Additional features and advantages of the present invention are described, and will be apparent from, the following Detailed Description of the Invention and the Figures.

### BRIEF DESCRIPTION OF THE FIGURES

FIG. 1 is a block diagram representation of both the word lists and interlinking list associated with the terminal and teachings of the present invention.

### DETAILED DESCRIPTION OF THE INVENTION

The present invention is based on a terminal for data processing technology and/or communications technology. This terminal has a text input aid which is based on word lists.

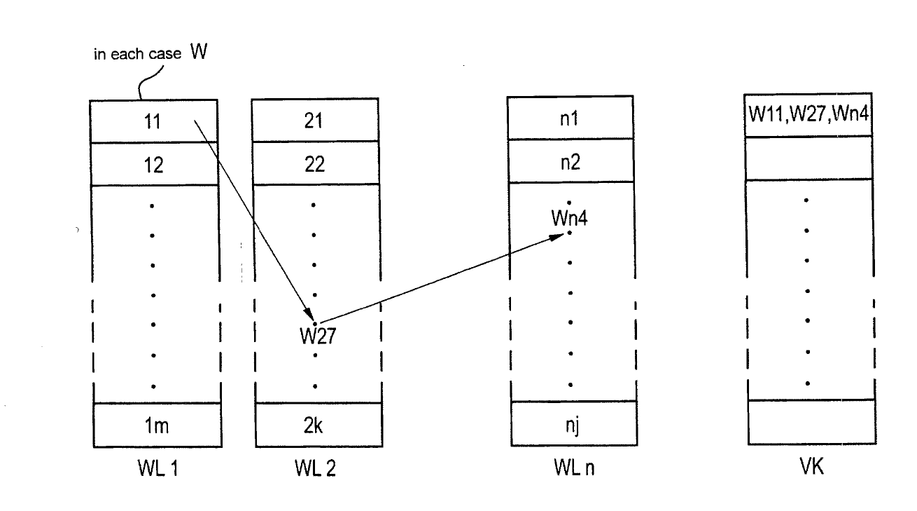

A number of such word lists WL1, WL2 to WLn are illustrated in FIG. 1. Each of these word lists WL1 to WLn has words from another language and is, therefore, language-specific. The word list WL1 has the words W11, W12 to W1n, the word list WL2 has the words W21, W22 to W2K, and the word list WLn has the words Wn1, Wn2 to Wnj. Here, for example, the numerical value of n is not equal to the numerical value of k. Each word Wxy has its own index in one of the word lists WL1 to WLn. Thus, a uniquely defined identification of the words Wxy can be provided via this index and the language.

According to the present invention, a further list is created in which interlinking of the individual words Wxy in the various languages is brought about. As a result, the functionality of a simple dictionary can be implemented; specifically, from any of the existing n languages into any of the other n-I languages.

In this further list, an interlinking list VK, such as the translation corresponding to the word W11 in the word list WL1, is given by the interlinking of the words Wxy. For this purpose, in the first line in which the word W11 appears in the list WL1, the associated words Wxy in the other word lists WLx are given. In the illustrated case, this is the word W27 in the word list WL2, and the word Wn4 in the word list WLn.

The user enters a word (W11), such as, in the language associated with the word list WL1 and is provided with the display of the associated word Wn4 in a different selectable language, such as in the language which is associated with the word list WLn.

In the interlinking list VK, the corresponding word indices for all the languages are then entered for each word index and each language. In this way, it is possible for a simple user program to identify and output the words in the desired foreign language which correspond to each word in a language.

In one embodiment of the present invention it is also possible to store multiple entries, such as for synonyms, in the interlinking list VK. In a further embodiment, additional linguistic information, such as that relating to the gender of the words, type of conjugation or pronunciation, also can be included in the interlinking list VK, and a virtually complete dictionary can be produced.

Although the present invention has been described with reference to specific embodiments, those of skill in art will recognize that changes may be made thereto with departing from the spirit and scope of the present invention as set forth in the hereafter appended claims.

1. A terminal for at least one of data processing and communications technology with multiply assigned input keys, comprising:
at least two language-specific word lists;
parts for assigning words in the word lists to characters which are input via the input keys; and
an interlinking list for listing corresponding words from the at least two language-specific word lists, wherein a dictionary function is implemented.
